(19) United States
(12) Patent Application Publication
(10) Pub. No.: US 2019/0202083 A1
(43) Pub. Date: Jul. 4, 2019

(54) ELECTRIC BANDSAW DEVICE

(71) Applicant: SAFETY CUT LTD, Tel Aviv (IL)

(72) Inventor: OMRI SHMUELI, Moshav Tal Shahar (IL)

(73) Assignee: SAFETY CUT LTD, Tel Aviv (IL)

(21) Appl. No.: 16/325,209

(22) PCT Filed: Aug. 17, 2017
(86) PCT No.: PCT/IL2017/050916

§ 371 Date: Feb. 13, 2019

Related U.S. Application Data
(60) Provisional application No. 62/383,908, filed on Sep. 6, 2016.
(60) Provisional application No. 62/381,795, filed on Aug. 31, 2016.
(60) Provisional application No. 62/376,644, filed on Aug. 18, 2016.

(51) Int. Cl. B27G 19/06; B27B 13/14; B23D 59/00

(52) U.S. Cl. CPC B27G 19/06; F16P 3/12; B23D 59/001; B27B 13/14

(57) ABSTRACT

The present invention is directed to an electric handsaw devices equipped with safety arrangement, capable of halting rotation of the bandsaw upon sensing of a body in the proximity of the blade of said bandsaw. The safety arrangements include braking pads or tension releasing means.

### TECHNOLOGICAL FIELD

The invention relates to electric band saw devices equipped with safety arrangement.

### BACKGROUND ART

References considered to be relevant as background to the presently disclosed subject matter are listed below:
AU 2006200946
GB2473061
U.S. Pat. No. 5,669,809

Acknowledgement of the above references herein is not to be inferred as meaning that these are in any way relevant to the patentability of the presently disclosed subject matter.

### BACKGROUND

A band saw device uses a blade consisting of a continuous band of toothed metal rotating on opposing wheels to cut material. Such band saw devices are typically used in woodworking, meat-cutting, metalworking, and lumbering, but may cut a variety of materials.

Advantages of using band saw devices include uniform cutting action as a result of an evenly distributed tooth load, and the ability to cut irregular or curved shapes like a jigsaw, or around and through hard materials such as bones. The minimum radius of a curve is determined by the width of the band and its kerf. Most band saw devices have two wheels connected by a belt or chain rotating in the same plane, one of which is powered, although some may have three or four to distribute the load.

The operator of the band saw device usually places the object to be cut on the platform, and pushes the object into the moving band saw in order to cut the object.

The operator must exert a forwards-force on the object to be cut, in order to push the object into the band saw. Because of the operator's hands are pushing the object to be cut into the moving blade, the operator must remain vigilant to avoid his hand or any other limb coming too close to the moving blade. Otherwise, the operator's hand can be severely cut by the band saw.

It is therefore extremely needed that a band saw device will be able to provide utmost safety measures to its operator being able to halt the band blade immediately as a limb of an operator is at close range with the blade, and on the other hand capable of returning the device back to operational mode, once the danger is removed.

### GENERAL DESCRIPTION

The present invention thus provides an electric bandsaw device capable of being operated by an operator comprising:

A sawing component comprising: (i) a constructions having at least one continuous bandsaw metal blade having two parallel faces; and at least two rotating wheels having at least a distance from each other in at least one direction, both connected to a motor; wherein said at least one continuous bandsaw metal blade is placed on said at least two wheels so that it is held in constant tension; and wherein when said rotating wheels are being rotated by said motor, said at least one continuous bandsaw metal blade is rotating on said wheels in the rotating direction; (ii) at least one sawing surface being perpendicular to said construction; wherein said sawing surface comprises an elongated gap wherein said at least one continuous bandsaw metal blade is fitted therein; and wherein a safety area at the proximity of said fitted at least one continuous bandsaw metal blade is predefined;

A sensing component comprising: at least one first sensing element placed above the sawing surface directed towards the predetermined safety area; and at least one second sensing element placed below the sawing surface directed towards the predetermined safety area; said sensing elements are capable of sensing a body or movement in the safety area of the sawing surface.

A halting component comprising: at least two parallel halting pads, each located facing one face of the at least one continuous bandsaw metal blade; having a sawing operation mode wherein said at least two halting pads are distant from said faces of continuous bandsaw metal blade; and a halting operation mode wherein said at least two halting pads are moving towards said continuous handsaw metal blade and with its rotating direction; said halting component is in communication with said sensing component;

Wherein upon said sensing component sensing a body in said predetermined safety area said halting component is being operated to halt said at least one continuous handsaw metal blade rotation.

In some embodiments, said at least one first sensor is selected from an RFID sensor, laser sensor, color sensor, motion sensor, proximity sensor, radio-wave sensor, temperature sensor, magnetic field sensor, ultrasound sensors, pressure sensor, sound-wave sensor, current sensor, voltage sensor, capacitive sensor, accelerometers, piezocapactive sensor, photoelectric sensor, inductive sensor, photodiode array sensor or any combinations thereof.

In other embodiments, said at least one second sensor is selected from an RFID sensor, laser sensor, color sensor, motion sensor, proximity sensor, radio-wave sensor, temperature sensor, magnetic field sensor, ultrasound sensors, pressure sensor, sound-wave sensor, current sensor, voltage sensor, capacitive sensor, accelerometers, piezocapactive sensor, photoelectric sensor, inductive sensor, photodiode array sensor or any combinations thereof.

In some embodiments, said at least one first sensor and at least one second sensor are the same. In other embodiments, said at least one first sensor and at least one second sensor are different. In further embodiments, said at least one first sensor is at least two first sensors. In other embodiments, said first and second sensors are motion or color sensors. In other embodiments, said motion sensor is a camera.

In some embodiments said halting pads are configured with a pneumatic assembly (for example at least one piston) enabling the simultaneous move of the pads towards the metal blade and with the rotating direction of the blade, thereby enabling the halting of the blade by geometrically locking the pads on the blade);

In further embodiments, said wherein said safety area is transparent. In other embodiments, said safety area is at least 0.1 cm².

In further embodiments, said halting of at least one continuous bandsaw metal blade rotation is done within less than about 0.5 sec.

The present invention further provides an electric band saw device capable of being operated by an operator comprising: a continuous metal blade; at least two engine rotating wheels; wherein said continuous metal blade is capable of being tensioned on said at least two engine rotating wheels; means for controlling the tensioning of said continuous metal blade over said at least two wheels; wherein said continuous metal blade is capable of cutting an object only at its tensioned form; a safety arrangement comprising: at least one sensor capable of sensing a live limb of an operator of said device at a predetermined proximity from said tensioned continuous metal blade; and at least one responder in communication with said sensor and said means for controlling the tension of said continuous metal blade; wherein upon sensing of a live limb at a predetermined proximity said responder communicates with said means for controlling the tension of said continuous metal blade so that the tension of said continuous metal blade is released.

In another one of its aspects, the invention provides an electric bandsaw device capable of being operated by an operator comprising: a continuous metal blade; at least two engine rotating wheels; wherein said continuous metal blade is capable of being tensioned and rotated on said at least two engine rotating wheels; wherein said continuous metal blade is capable of cutting an object only at its tensioned form while being rotated when said device is operated by said operator; a safety arrangement comprising: at least one sensor capable of sensing a live limb of an operator of said device at a predetermined proximity from said tensioned continuous metal blade; and at least one tension controlling element in communication with said sensor having an enabling and disabling modes; wherein upon operation of said device, said continuous metal blade is kept tensioned and rotating on said at least two engine rotating wheels, and said tension controlling element is kept at the enabling mode; and wherein upon sensing of a live limb at said predetermined proximity to said continues blade, said tension controlling means switches to a disabling mode thereby releasing the tension of said of said continuous metal blade on said at least two engine rotating wheels, thereby also stopping the rotation of said continuous metal blade.

In some embodiments, the sensor is selected from an RFID sensor, laser sensor, motion sensor, proximity sensor, radio-wave sensor, temperature sensor, magnetic field sensor, ultrasound sensors, pressure sensor, sound-wave sensor, current sensor, voltage sensor, capacitive sensor, accelerometers, piezocapactive sensor, photoelectric sensor, inductive sensor, photodiode array sensor or any combinations thereof.

In some embodiments, said sensor is attached to at least one camera. In some embodiments, said at least one camera is aimed at an operational area (defined as the safety area) of said bandsaw blade which is used by said operator.

In other embodiments, the predetermined proximity from said tensioned continuous metal blade is at least 0.1 cm.

In further embodiments, the tension of said continuous metal blade is released upon sensing said limb within less than 0.5 sec.

In other embodiments, said electric bandsaw device further comprises a tag for attachment to the limbs of said operator; wherein said sensor is capable of sensing said tag within said predetermined proximity from said tensioned continuous metal blade.

In some embodiments, said at least one tension controlling element is in contact communication with said continues blade. Thus, in its enabling mode, the tension controlling element keeps the tension of said continues blade on said at least two engine rotating wheels which rotate said blade. Upon sensing the proximity of a limb to said blade, the tension controlling element switches to the disabling mode, wherein it releases the tension of said blade on said at least two engine rotating wheels which allows for the blade to stop its rotation.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a band saw device of the invention and some of its parts and components.

FIG. 2 shows the operational area of the band saw that is defined as the safety area around the band saw blade.

FIGS. 3A-3B show angles of the cameras aimed at the safety area around said band saw blade.

FIGS. 4A-4B shows the additional safety clamps capable of holding said band saw blade upon release of tension of said blade (FIG. 4A band saw blade routine operation, FIG. 4B clamped blade upon release of blade tension).

FIGS. 5A-5B shows the operational tense state of the band saw blade (FIG. 5A) and the released state of the band saw blade (FIG. 5B).

FIG. 6 shows the arrangement of the tension holding screw of said band saw blade.

FIGS. 7A-7C shows the operational state (FIG. 7A), released state (FIG. 7B and FIG. 7C) of the tension holding screw of said band saw blade.

FIGS. 8A-8C shows the device of the invention comprising said tension controlling element (FIG. 8A) having an enabling mode (FIG. 8B) and a disabling mode (FIG. 8C).

FIG. 9 is an illustrative scheme of an electric bandsaw device of the invention capable of being operated by an operator.

FIGS. 10A and 10B show the sensing component of a device of the invention.

FIG. 11 shows the halting component of a device of the invention.

### DETAILED DESCRIPTION OF EMBODIMENTS

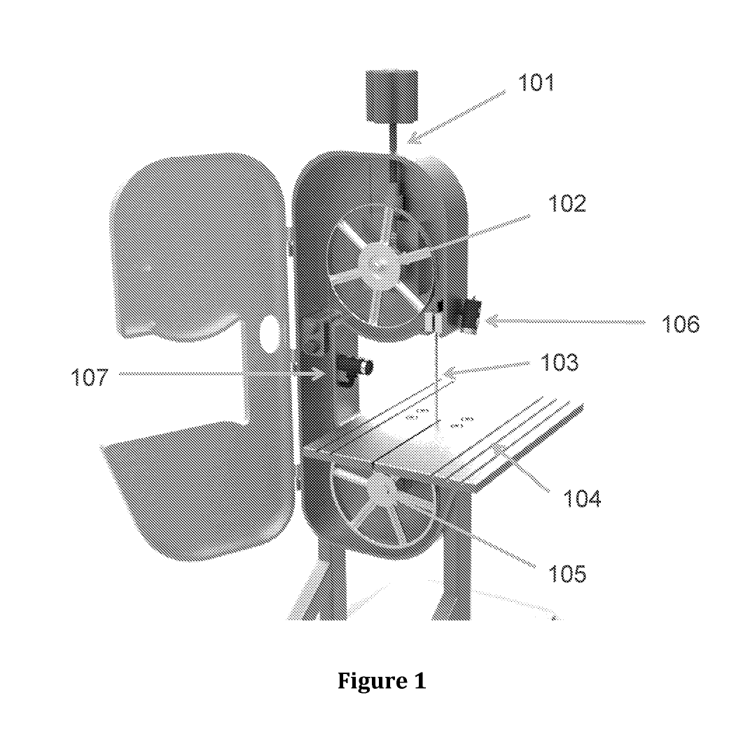

FIG. 1 shows an exemplary embodiment of the present invention band saw device (100) equipped with a safety arrangement. Element 101 is a tension holding screw capable of holding the band saw continuous blade (103) between the two wheels (102 and 105) in a tense mode. The device shows two cameras (106 and 107) that are aimed at the cutting table (104) area which is used by the operator of the device cutting an object through the blade 103 held on the table 104.

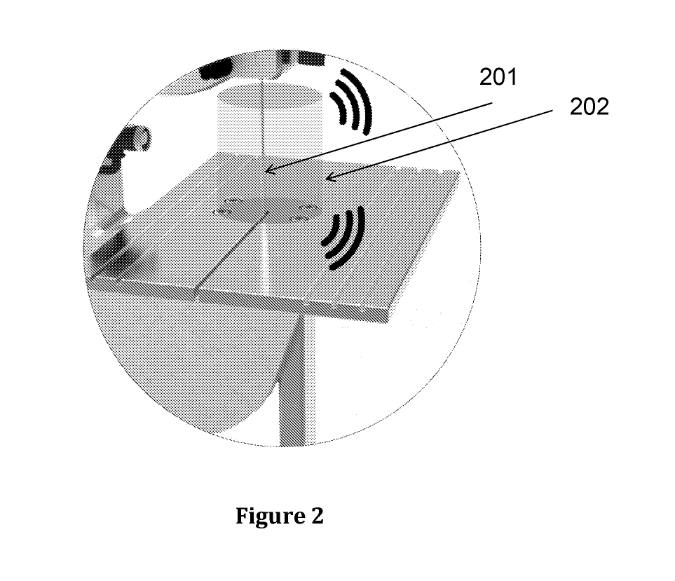

FIG. 2 shows the operational area of the band saw blade (201) that is defined as the safety area (202) around the band saw blade.

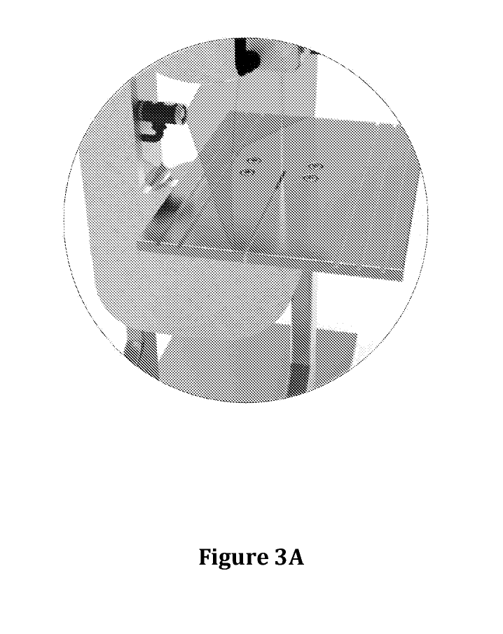

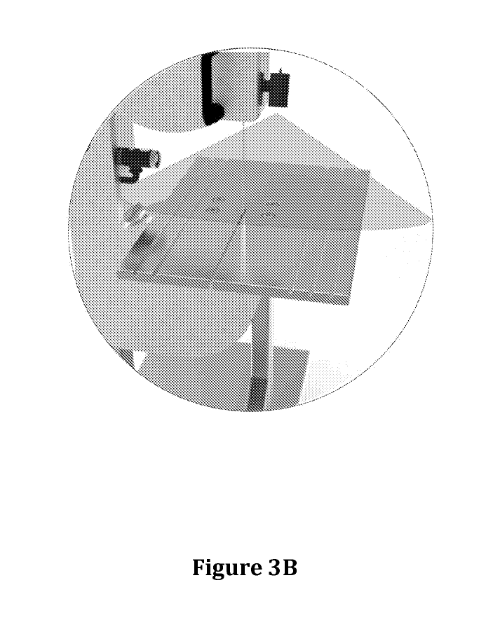

FIGS. 3A and 3B show two angles of the cameras aimed at the safety area around said band saw blade. The overhead camera (FIG. 3B) and the side camera (FIG. 3A) give double coverage of the safety area.

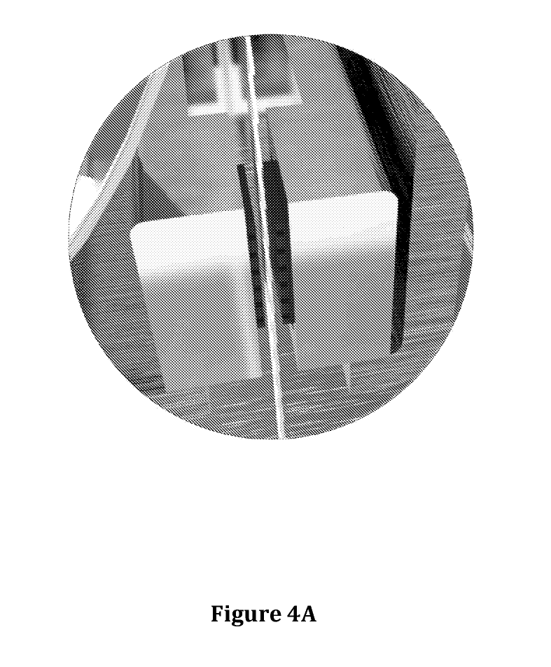

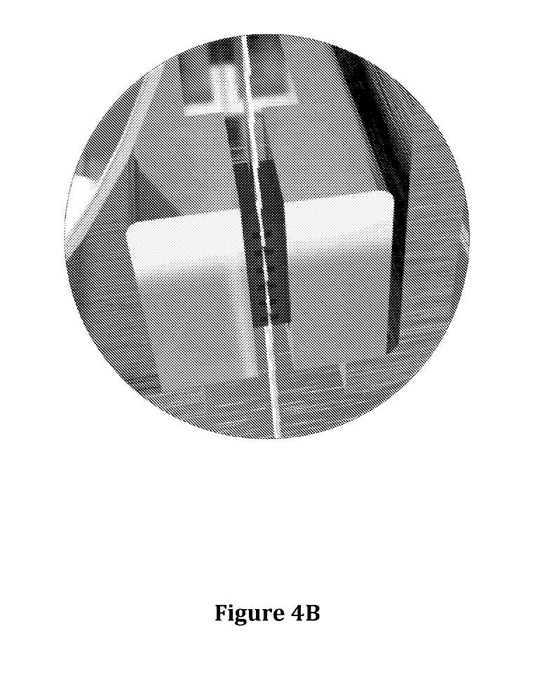

FIGS. 4A-4B shows the additional safety clamp feature of a device of the invention that are capable of holding said band saw blade upon release of tension of said blade (FIG. 4A band saw blade routine operation, FIG. 4B clamped blade upon release of blade tension).

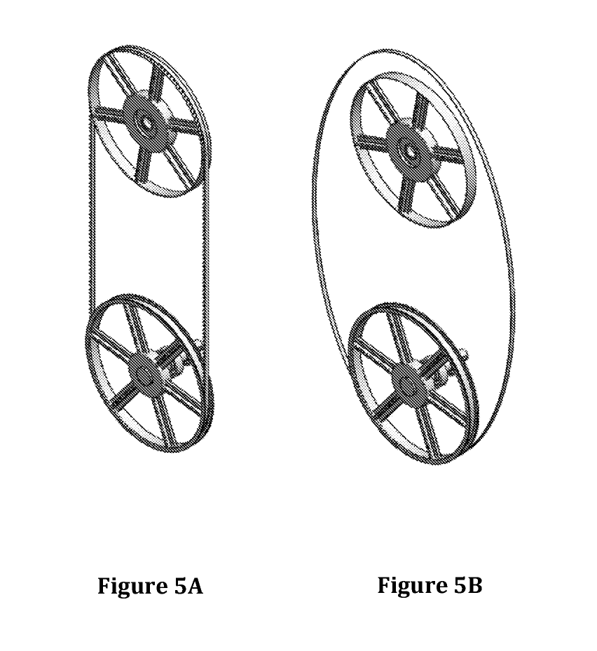

FIGS. 5A-5B shows the operational tense state of the band saw blade (FIG. 5A) and the released state of the band saw blade upon which the band saw device is deactivated (FIG. 5B).

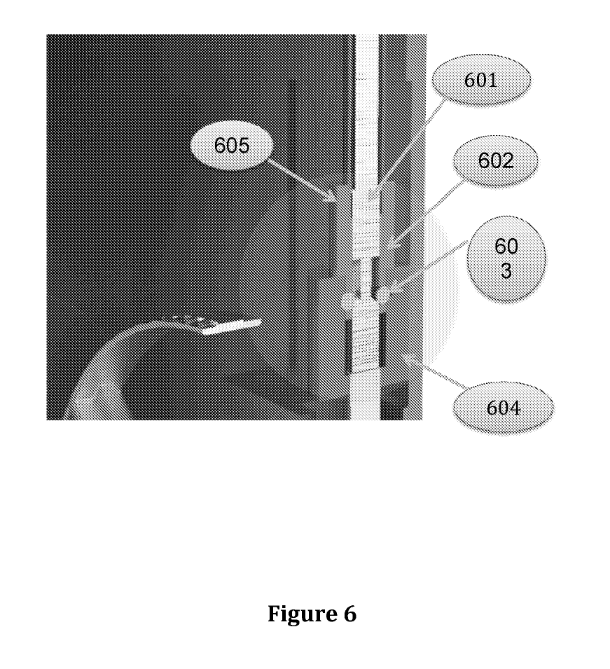

FIG. 6 shows the arrangement of the tension holding screw of said band saw blade. 601 is the lead pin that holds down the bearings (603) into the niches in the bottom part of the screw (604). 605 being the return spring that is capable of holding the lead pin in place or release it from place.

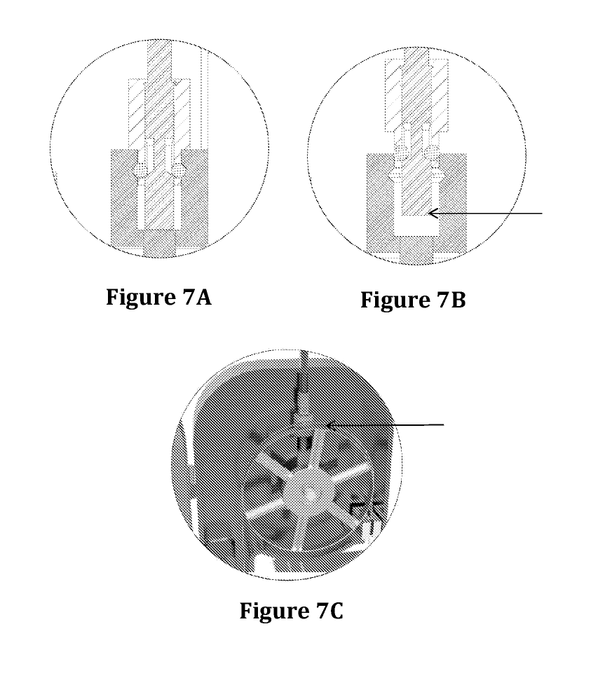

FIGS. 7A-7C shows the operational state (FIG. 7A), released state (FIG. 7B and FIG. 7C) of the tension holding screw of said band saw blade upon which the blade is deactivated.

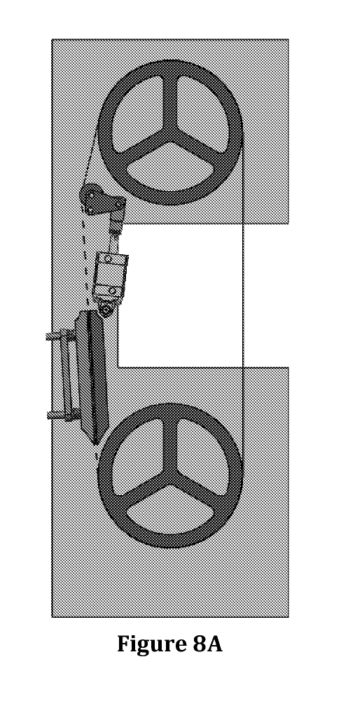

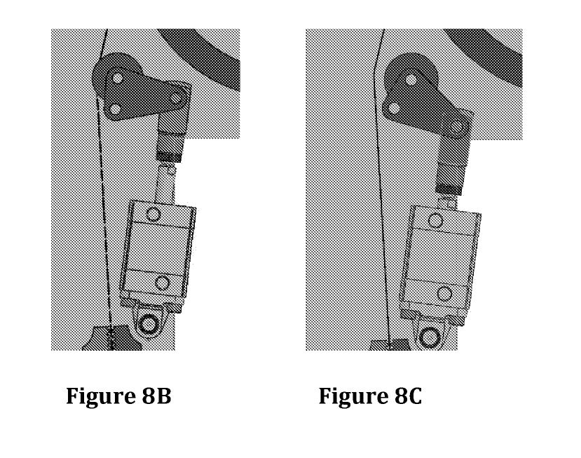

FIG. 8A shows an electric bandsaw device of the invention capable of being operated by an operator comprising: a continuous metal blade; two engine rotating wheels; wherein said continuous metal blade is capable of being tensioned and rotated on said at least two engine rotating wheels; wherein said continuous metal blade is capable of cutting an object only at its tensioned form while being rotated when said device is operated by said operator; a safety arrangement comprising: a sensor capable of sensing a live limb of an operator of said device at a predetermined proximity from said tensioned continuous metal blade; and a tension controlling element in communication with said sensor having an enabling mode (FIG. 8B) and disabling mode (FIG. 8C); wherein upon operation of said device, said continuous metal blade is kept tensioned and rotating on said at least two engine rotating wheels, and said tension controlling element is kept at the enabling mode; and wherein upon sensing of a live limb at said predetermined proximity to said continues blade, said tension controlling means switches to a disabling mode thereby releasing the tension of said of said continuous metal blade on said at least two engine rotating wheels, thereby also stopping the rotation of said continuous metal blade.

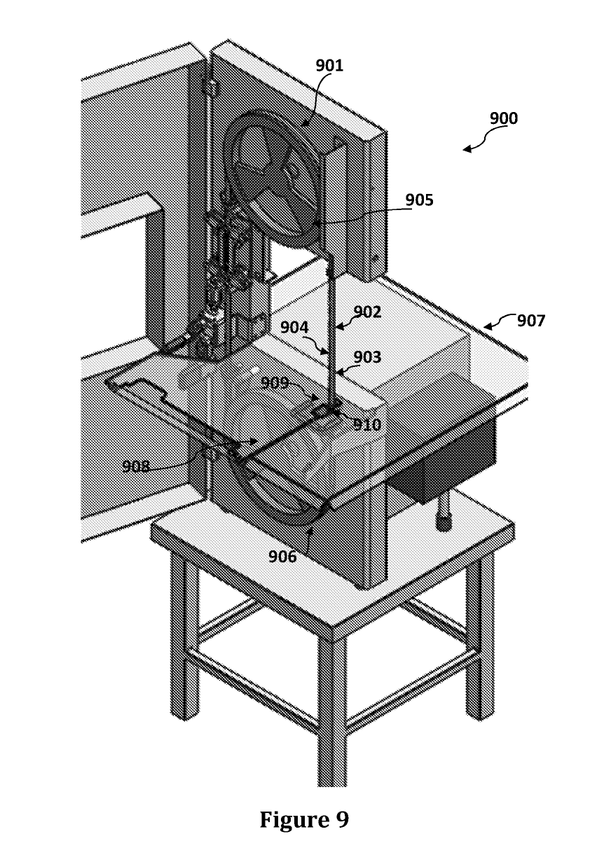

FIG. 9 provides an illustrative scheme of an electric bandsaw device of the invention capable of being operated by an operator (900). The sawing component (901) of the device is showing a construction having one continuous bandsaw metal blade (902) having two parallel faces (903 and 904); and two rotating wheels (905 and 906) having at least a distance from each other in at least one direction (thus making 905 the upper wheel and the 906 the lower wheel—below the sawing surface 907), both connected to a motor (not shown); wherein said continuous bandsaw metal blade is placed on said at least two wheels so that it is held in constant tension; and wherein when said rotating wheels are being rotated by said motor, said continuous bandsaw metal blade is rotating on said wheels in the rotating direction.

FIG. 9 further shows the sawing surface (907) that is perpendicular to said construction; wherein said sawing surface comprises an elongated gap (908) wherein said continuous bandsaw metal blade is fitted therein (909); and wherein a safety area at the proximity of said fitted continuous bandsaw metal blade is predefined (910).

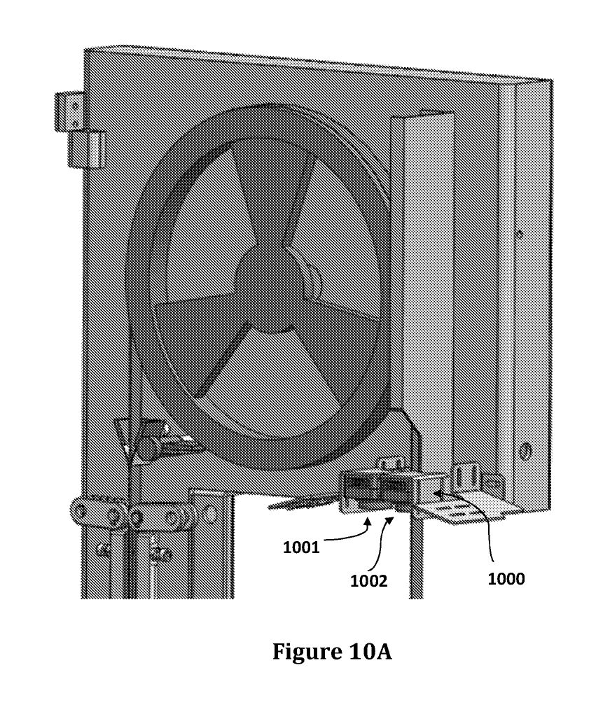

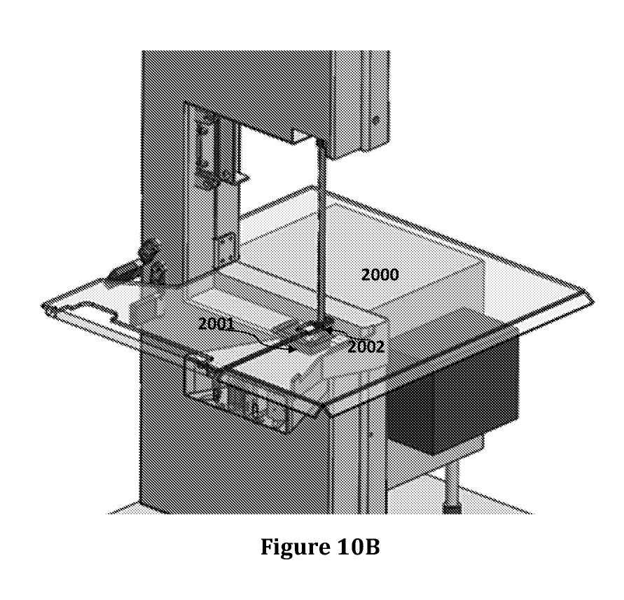

FIGS. 10A and 10B show the sensing component of a device of the invention (1000). FIG. 10A shows the first sensing element placed above the sawing surface. Said first sensing element in FIG. 10A comprises two upper cameras (1001 and 1002) placed at the proximity of the continuous bandsaw metal blade above the predetermined safety area on the sawing surface. FIG. 10B shows the second sensing element placed below the sawing surface (2000). Said second sensing element in FIG. 10B comprises one lower camera (2001) placed at the proximity of the continuous bandsaw metal blade below the predetermined safety area on the sawing surface (2002).

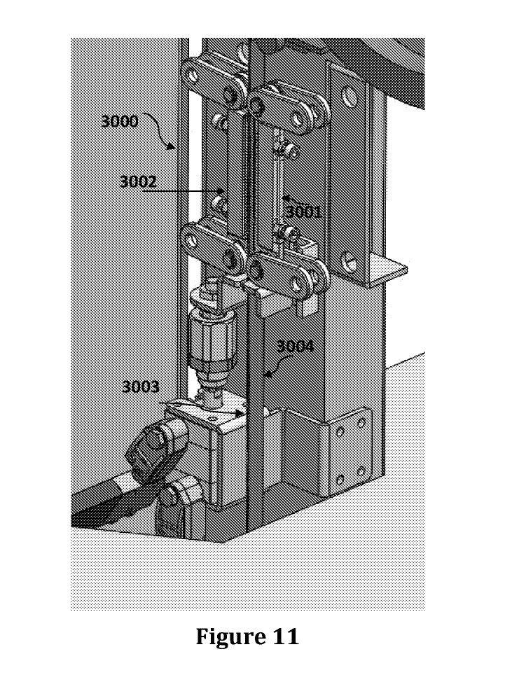

FIG. 11 shows the halting component of a device of the invention (3000). FIG. 11 shows two parallel halting pads (3001 and 3002), each located facing one face of the continuous bandsaw metal blade (3003 and 3004); having a sawing operation mode wherein said at least two halting pads are distant from said faces of continuous bandsaw metal blade (not shown); and a halting operation mode wherein said at least two halting pads are moving towards said continuous bandsaw metal blade and with the rotating direction; said halting component is in communication with said sensing component. Wherein upon said sensing component sensing a body in said predetermined safety area said halting component is being operated to halt said at least one continuous bandsaw metal blade rotation.

1. An electric handsaw device capable of being operated by an operator comprising:
A sawing component comprising:
a constructions having at least one continuous handsaw metal blade having two parallel faces; and at least two rotating wheels having at least a distance from each other in at least one direction, both connected to a motor; wherein said at least one continuous handsaw metal blade is placed on said at least two wheels so that it is held in constant tension; and wherein when said rotating wheels are being rotated by said motor, said at least one continuous handsaw metal blade is rotating on said wheels in the rotating direction;
at least one sawing surface being perpendicular to said construction;
wherein said sawing surface comprises an elongated gap wherein said at least one continuous handsaw metal blade is fitted therein; and wherein a safety area at the proximity of said fitted at least one continuous handsaw metal blade is predefined;
A sensing component comprising:
at least one first sensing element placed above the sawing surface;
at least one second sensing element placed below the sawing surface;
A halting component comprising:
at least two parallel halting pads, each located facing one face of the at least one continuous handsaw metal blade; having a sawing operation mode wherein said at least two halting pads are distant from said faces of continuous handsaw metal blade; and a halting operation mode wherein said at least two halting pads are moving towards said continuous handsaw metal blade and with the rotating direction; said halting component is in communication with said sensing component;
Wherein upon said sensing component sensing a body in said predetermined safety area said halting component is being operated to halt said at least one continuous handsaw metal blade rotation.

2. The electric handsaw device of claim 1, wherein said at least one first sensor is selected from an RFID sensor, laser sensor, color sensor, motion sensor, proximity sensor, radio-wave sensor, temperature sensor, magnetic field sensor, ultrasound sensors, pressure sensor, sound-wave sensor, current sensor, voltage sensor, capacitive sensor, accelerometers, piezocapactive sensor, photoelectric sensor, inductive sensor, photodiode array sensor or any combinations thereof.

3. The electric handsaw device of claim 1, wherein said at least one second sensor is selected from an RFID sensor, laser sensor, color sensor, motion sensor, proximity sensor, radio-wave sensor, temperature sensor, magnetic field sensor, ultrasound sensors, pressure sensor, sound-wave sensor, current sensor, voltage sensor, capacitive sensor, accelerometers, piezocapactive sensor, photoelectric sensor, inductive sensor, photodiode array sensor or any combinations thereof.

4. The electric handsaw device of claim 1, wherein said at least one first sensor and at least one second sensor are the same.

5. The electric handsaw device of claim 1, wherein said at least one first sensor and at least one second sensor are different.

6. The electric handsaw device of claim 1, wherein said at least one first sensor is at least two first sensors.

7. The electric handsaw device according to claim 1, wherein said first and second sensors are motion or color sensors.

8. (canceled)

9. The electric handsaw device according to claim 1, wherein said wherein said safety area is transparent.

10. The electric handsaw device according to claim 1, wherein said safety area is at least 0.1 cm².

11. The electric handsaw device according to claim 1, wherein the halting of at least one continuous handsaw metal blade rotation is done within less than about 0.5 sec.

12.-18. (canceled)
